(19) United States
(12) Patent Application Publication
(10) Pub. No.: US 2003/0222464 A1
(43) Pub. Date: Dec. 4, 2003

(54) Adjustable button mechanism for a lock

(75) Inventor: Lan-Kun Don, Chiayi (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: Tung Lung Metal Industry Co., Ltd.

(21) Appl. No.: 10/452,427

(22) Filed: Jun. 3, 2003

(30) Foreign Application Priority Data
Jun. 4, 2002 (TW) 091208291

(51) Int. Cl. E05B 1/00

(52) U.S. Cl. 292/347; 292/169

(57) ABSTRACT

An adjustable button mechanism for a lock includes: a driving tube of a hollow tubular shape, having a first end and a second end, the first end connecting to a driving mechanism of the lock, the second end forming a positioning slot; a connecting member having a first end forming an axial hole and a second end; a protruding member formed at the first end of the connecting member and radially extending into the positioning slot of the driving tube; a button lever placed within the driving tube, and having a first end and a second end, the first end connecting to the driving mechanism, the second end being inserted into the axial hole of the connecting member; and a button placed on the second end of the connecting member, and either the connecting member or the button having an elastically supported lateral member, with the other containing a plurality of holes for selectively receiving the lateral member.

### BACKGROUND OF THE INVENTION

(A) Field of the Invention

The present invention relates to an adjustable button mechanism for a lock. Particularly, the present invention relates to a button and button lever combination for an adjustable lock and modifies the lock disclosed in ROC (Taiwan) New Utility Model Pat. Appln. No. 090200573 which was filed on Jan. 11, 2001 by the Inventor of the present invention and published on Feb. 11, 2002 under Pat. Pub. No. 476368.

(B) Description of the Relevant Art

FIGS. 1 to 3 illustrate a lock disclosed in ROC (Taiwan) New Utility Model Pat. Appln. No. 090200573. As illustrated, the lock comprises a latch 1, a driving mechanism 2 for driving the latch 1, and a round covering set 3 for clamping the driving mechanism 2 and fixing it on the door panel, wherein the driving mechanism 2 comprises:

a button lever 23 having one end connecting to the driving mechanism 2, and the other end formed with a plurality of slots 231; and

a button 24 having an adjusting plate 25 which is selective to engage with one of the slots 231 of the button lever 23.

Based on the above construction, the lock can be adjusted to be installed on a thick door panel (See FIG. 2), as well as on a thin door panel (See FIG. 3).

However, in view of the fact that there are still many different kinds of operating modes needed for the adjustment of the reciprocal combination position of the button and the button lever for locks, the present invention is, hence, created in order to satisfy the needs of different users.

### SUMMARY OF THE INVENTION

Therefore, the primary objective of the present invention is to provide an adjustable button mechanism for a lock.

A further objective of the present invention is to provide a mechanism which makes the adjustment of the reciprocal combination position of the button and the button lever easier.

Based on the above objectives, the adjustable button mechanism for a lock in accordance with the present invention includes:

a driving tube of a hollow tubular shape, having a first end and a second end, the first end connecting to a driving mechanism of the lock, the second end forming a positioning slot;

a connecting member having a first end forming an axial hole and a second end;

a protruding member formed at the first end of the connecting member and radially extending into the positioning slot of the driving tube;

a button lever placed within the driving tube, and having a first end and a second end, the first end connecting to the driving mechanism, the second end being inserted into the axial hole of the connecting member; and

a button placed on the second end of the connecting member, and either the connecting member or the button having an elastically supported lateral member, with the other containing a plurality of holes for selectively receiving the lateral member.

The structure and objectives of the present invention can be more readily understood by persons skilled in the art from the following description of the preferred embodiments taken in conjunction with the accompanying drawings.

### BRIEF DESCRIPTION OF THE DRAWINGS

FIG. 1 is an exploded view of a lock disclosed in ROC New Model Patent Application No. 090200573;

FIG. 2 is a partial sectional view of the lock illustrated in FIG. 1 which is installed on a thick door panel;

FIG. 3 is a partial sectional view of the lock illustrated in FIG. 1 which is installed on a thin door panel;

FIG. 4 is an exploded view of an adjustable button mechanism for a lock in accordance with the present invention;

FIG. 5 is a perspective view of an adjustable button mechanism for a lock in accordance with the present invention, wherein the length of the mechanism is adjusted to be long;

FIG. 6 is a perspective view of an adjustable button mechanism for a lock in accordance with the present invention, wherein the length of the mechanism is adjusted to be short;

FIG. 7 is a schematic view of an adjustable button mechanism for a lock in accordance with the present invention, illustrating the positioning of the button by pressing the button and rotating the button with an angular displacement;

FIG. 8 is a schematic view of an adjustable button mechanism for a lock in accordance with the present invention, wherein the mechanism is placed within the lock and the lock is installed onto a thick door panel, wherein the length of the mechanism is adjusted to be long; and

FIG. 9 is a schematic view of an adjustable button mechanism for a lock in accordance with the present invention, wherein the mechanism is placed within the lock and the lock is installed onto a thin door panel, wherein the length of the mechanism is adjusted to be short.

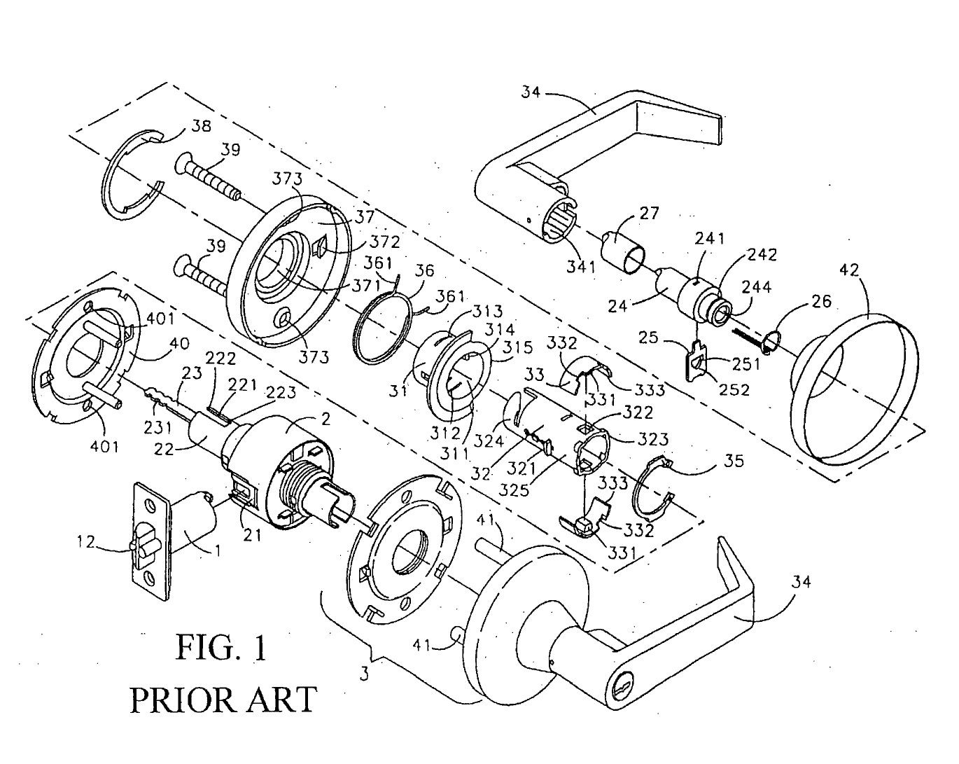

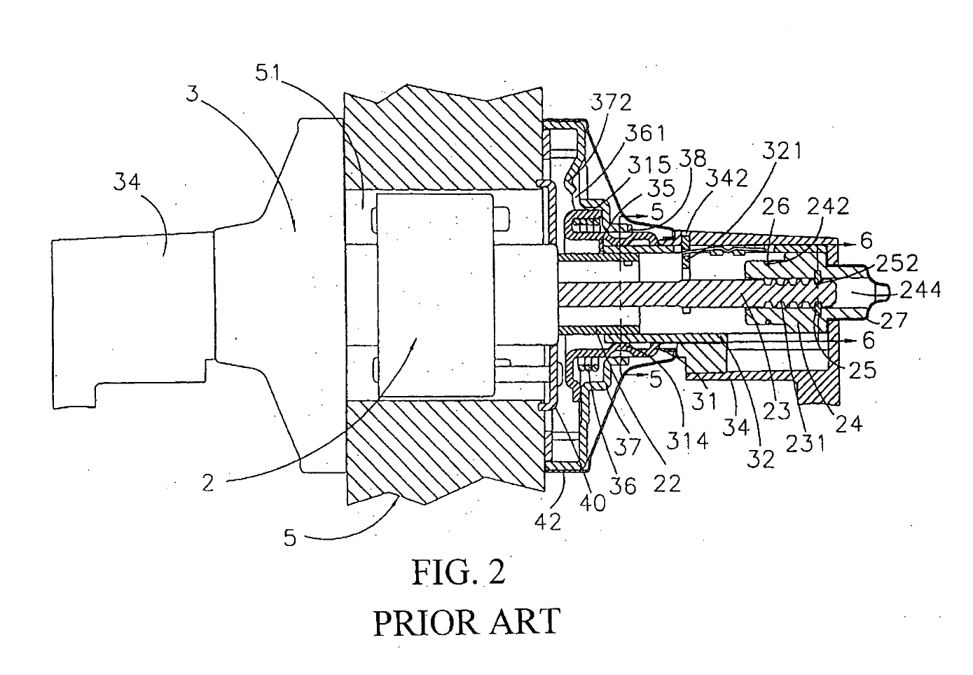

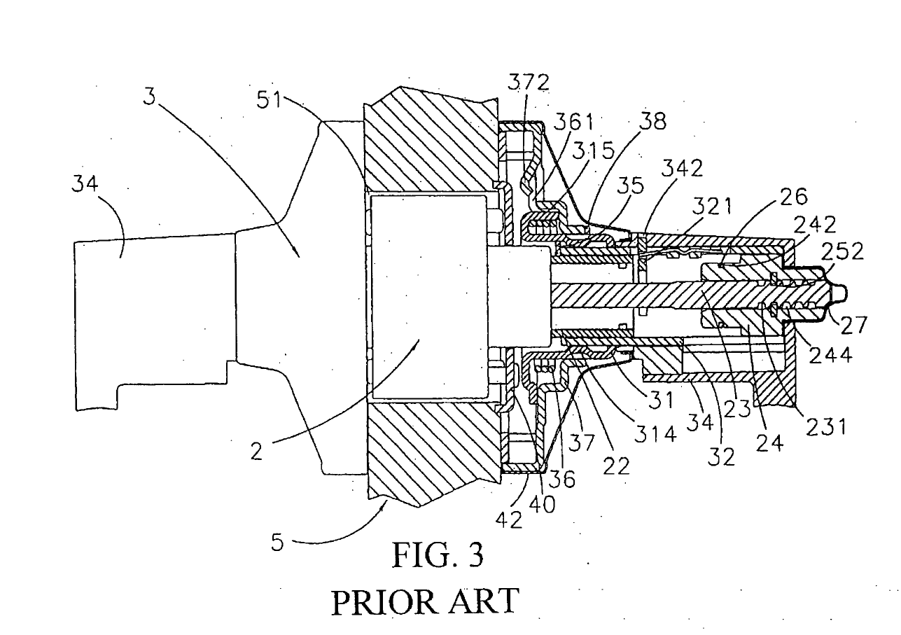

### DETAILED DESCRIPTION OF THE INVENTION

The adjustable button mechanism for a lock in accordance with the preferred embodiment of the present invention can be described, with the accompanying drawings, in further detail as follows:

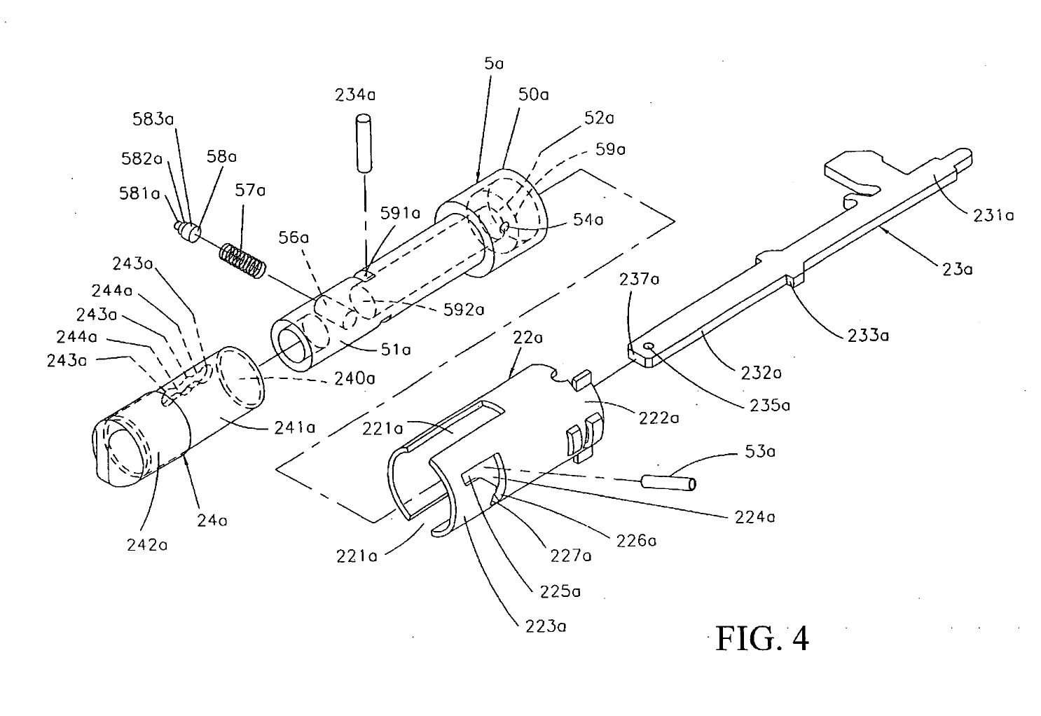

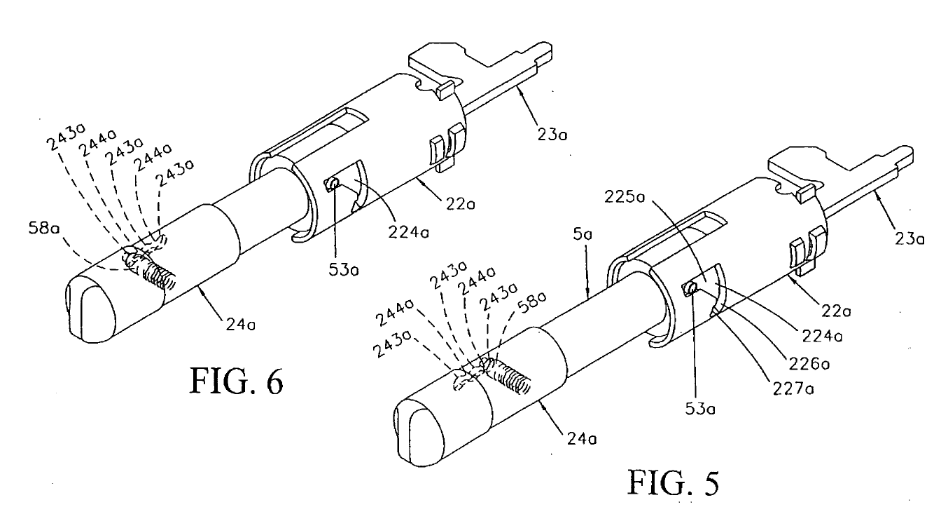

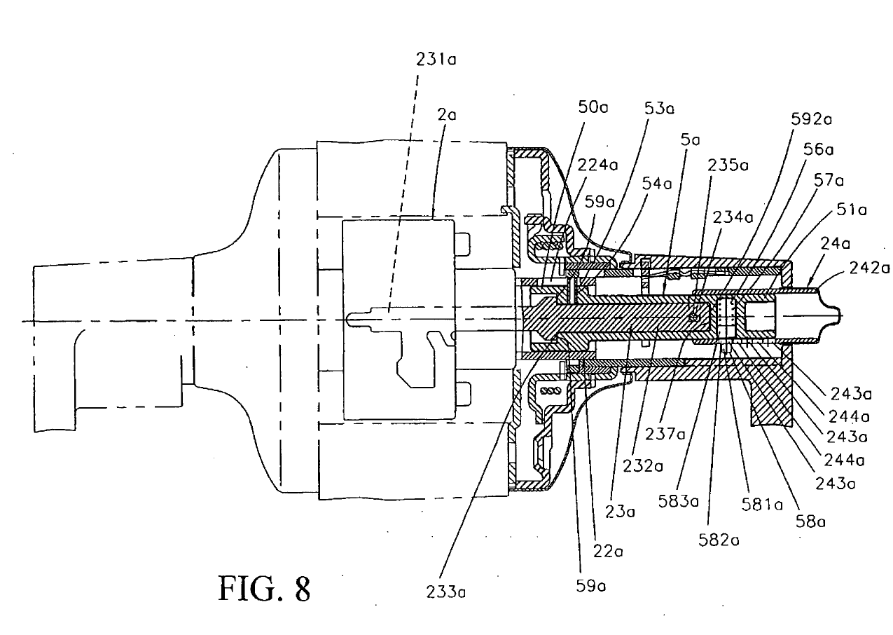

As illustrated in FIG. 4, FIG. 5, and FIG. 8, the adjustable button mechanism for a lock in accordance with a preferred embodiment of the present invention comprises a driving tube 22a, a connecting member 5a, a button lever 23a, and a button 24a.

The driving tube 22a is of a hollow tubular shape which comprises a first end 222a and a second end 223a. The first end 222a connects to a driving mechanism 2a of a lock and the second end 223a defines a pair of axial slots 221a, 221a diametrically opposite to each other. An L-shaped positioning slot 224a, consisting of an axial slot 225a and a lateral slot 226a orthogonally interconnected at an end thereof, is formed on the wall of the driving tube 22a. A shoulder 227a is further formed from an edge of the lateral slot 226a.

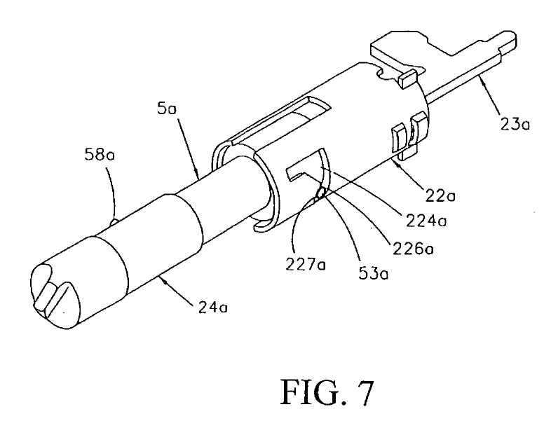

The connecting member 5a has a first end 50a and a second end 51a. The first end 50a forms an axial hole 52a, as well as an engaging portion 59a therein. The axial hole 52a defines a bottom face 592a. A radially outward protruding member 53a is further formed on the wall near the first end 50a by integrally forming with the first end 50a, or by presetting a hole 54a on the first end 50a and inserting a pin 53a thereinto. The connecting member 5a is received within the driving tube 22a such that in an unlocked state, the protruding member 53a is located within the axial slot 225a of the positioning slot 224a of the driving tube 22a (as shown in FIG. 5); and in a locked state, the protruding member 53a is pressed against the shoulder 227a of the lateral slot 226a of the driving tube 22a (as shown in FIG. 7).

A lateral slot 591a is further formed between the first end 50a and the second end 51a of the connecting member 5a, and communicates to the axial hole 52a of the connecting member 5a.

Near the second end 51a of the connecting member 5a, a lateral hole 56a is formed for receiving an elastic member or a spring 57a, and a lateral member 58a. The lateral member 58a can be a pin with unequal cross sections (stepped) or a plate. In the current embodiment, the lateral member is a pin 58a supported by the spring 57a. The pin 58a is stepped and defines a first section 581a, a second section 582a and a third section 583a, wherein the diameter of the cross section of the second section 582a is larger than that of the first section 581a and is smaller than that of the third section 583a.

The button lever 23a is also received within the driving tube 22a, and contains a first end 231a and a second end 232a. The first end 231a connects to the driving mechanism 2a and is supported by a spring (not shown). A protruding member 234a is formed at the second end 232a by integrally forming therewith, or by presetting a hole 235a on the second end 232a and inserting a pin 234a thereinto. By engaging the protruding member 234a with the lateral slot 591a of the connecting member 5a, the second end 232a of the button lever 23a is placed within the axial hole 52a of the connecting member 5a and the connecting member 5a can rotate a certain angular displacement with respect to the button lever 23a.

The button lever 23a further comprises an engaging portion 233a for engaging with the engaging portion 59a of the connecting member 5a. In the current embodiment, the engaging portion 233a is formed between the first end 231a and the second end 232a. In addition, the second end 232a of the button lever 23a can have an end face 237a which abuts on the bottom face 592a of the axial hole 52a.

As shown in FIG. 4, the button 24a has a first end 241a and a second end 242a. The second end 242a has a gripping surface. Further, the first end 241a is formed with an axial hole 240a for fitting to the second end 51a of the connecting member 5a. In addition, a serial of holes 243a are formed laterally on the wall of the button 24a with the adjacent holes 243a communicating to each other by means of a groove 244a.

The diameter of the cross section of the first section 581a of the lateral member 58a of the connecting member 5a is less than the width of the groove 244a. Further, the diameter of the cross section of the second section 582a is less than the diameter of the hole 243a and larger than the width of the groove 244a. In addition, the diameter of the cross section of the third section 583a is larger than the diameter of the hole 243a. Accordingly, since the lateral member 58a is elastically supported by the spring 57a, by fitting the button 24a to the second end 51a of the connecting member 5a, the lateral member 58a of the connecting member 5a can selectively and adjustably engage with one of the holes 243a.

Based on the above disclosure, the adjustable button mechanism for a lock in accordance with the present invention is constructed. As shown in FIG. 5, the length of the adjustable button mechanism is adjusted to be long; and as shown in FIG. 6, the length of the adjustable button mechanism is adjusted to be short.

To set the button in a locked state, first, a user presses the button 24a such that the button 24a, the connecting member 5a, and the button lever 23a move axially with respect to the driving tube 22a. At this moment, the protruding member 53a of the connecting member 5a reaches the end of the axial slot 225a, as well as the end of the lateral slot 226a. By further rotating the button 24a, the button 24a and the connecting member 5a create an angular displacement with respect to the driving tube 22a. At this moment, the protruding member 53a of the connecting member 5a will be positioned by the shoulder 227a of the lateral slot 226a of the driving tube 22a, as shown in FIG. 7.

The adjustable button mechanism for a lock of the present invention can be installed or combined to locksets. Since the parts and effects of locks, such as the driving mechanism, the round covering set, and the handle have been described in detail previously in ROC (Taiwan) New Utility Model Pat. Appln. No. 090200573, such reference is not intended to be set forth herein to avoid redundancy.

FIG. 8 is a schematic view of an adjustable button mechanism for a lock in accordance with the present invention, wherein the mechanism is placed within the lock and the lock is installed onto a thick door panel, wherein the length of the mechanism is adjusted to be long.

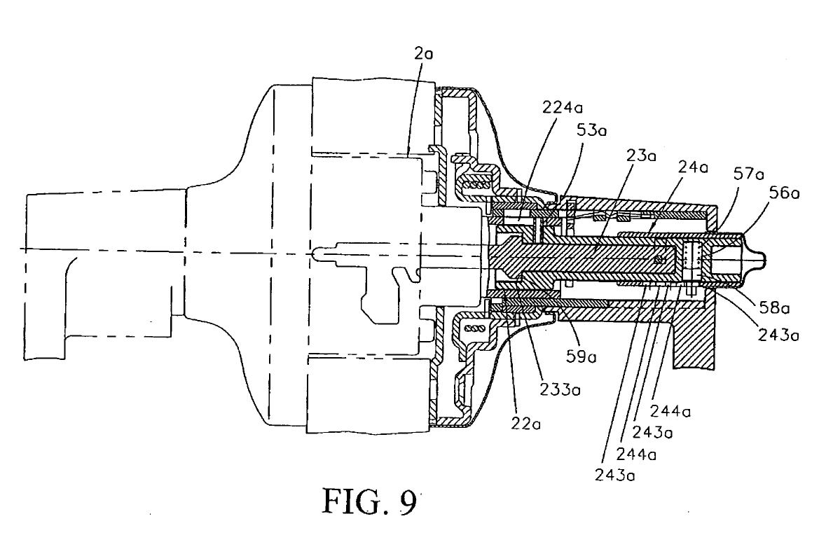

FIG. 9 is a schematic view of an adjustable button mechanism for a lock in accordance with the present invention, wherein the mechanism is placed within the lock and the lock is installed onto a thin door panel, wherein the length of the mechanism is adjusted to be short.

Additionally, the adjustable button mechanism of the present invention can have modifications with respect to the fitting between the connecting member 5a and the button 24a. For instance, an axial hole can be formed at the second end 51a of the connecting member 5a to receive the first end 241a of the button 24a, while a plurality of holes, as well as the intercommunicated grooves are formed at the second end 51a of the connecting member 5a. Further, a lateral hole is formed at the first end 241a of the button 24a to receive a spring and a lateral member such that the lateral member can selectively engage with one of the plurality of holes. Such an equivalent change in structure, even with the other relevant elements unchanged, is still possible to achieve the performances specifically proclaimed hereinbefore by the embodiment of the present invention.

The above descriptions have clearly illustrated the important features, operational methods and applications of the present invention. Although the invention has been described with reference to the preferred embodiments, it will be obvious to persons skilled in the art that various changes and modifications may be made without departing from the scope of the invention as recited in the claims.

What is claimed is:

1. An adjustable button mechanism for a lock, comprising:
a driving tube of a hollow tubular shape, having a first end and a second end, said first end connecting to a driving mechanism of said lock, and said second end forming a positioning slot;
a connecting member having a first end and a second end, said first end forming an axial hole, and said second end forming a lateral hole;
a protruding member formed at said first end of said connecting member and radially extending into said positioning slot of said driving tube;
a button lever placed within said driving tube, and having a first end and a second end, said first end connecting to said driving mechanism of said lock, and said second end being inserted into said axial hole of said connecting member;
an elastically supported lateral member supported by said elastic member and received with in said lateral hole of said connecting member; and
a button placed on said second end of said connecting member, said button laterally forming with a plurality of holes for selectively receiving said lateral member.

2. The adjustable button mechanism as claimed in claim 1, wherein a groove is formed for communication between two adjacent holes of said button.

3. The adjustable button mechanism as claimed in claim 2, wherein said lateral member is a pin.

4. The adjustable button mechanism as claimed in claim 1, wherein said button lever and said connecting member respectively have an engaging portion for reciprocal contact thereof.

5. The adjustable button mechanism as claimed in claim 1, wherein said button lever further has a protruding member and said connecting member further has a lateral slot for engaging with said protruding member of said button lever.

6. The adjustable button mechanism as claimed in claim 1, wherein said positioning slot is formed by orthogonally interconnecting an axial slot to a horizontal slot.

7. An adjustable button mechanism for a lock, comprising:
a driving tube of a hollow tubular shape, having a first end and a second end, said first end connecting to a driving mechanism of said lock, and said second end forming a positioning slot;
a connecting member having a first end and a second end, said first end forming an axial hole;
a protruding member formed at said first end of said connecting member and radially extending into said positioning slot of said driving tube;
a button lever placed within said driving tube, and having a first end and a second end, said first end connecting to said driving mechanism of said lock, and said second end being inserted into said axial hole of said connecting member;
a button placed on said second end of said connecting member, and one of said connecting member and said button having an elastically supported lateral member, while the other containing a plurality of holes for selectively receiving the lateral member.
